(19) United States
(12) Patent Application Publication
(10) Pub. No.: US 2008/0000334 A1
(43) Pub. Date: Jan. 3, 2008

(54) Device for Supporting Bogies on Wheel Set Machining Units

(76) Inventors: Hans-Joachim Reiche, Erkrath (DE); Dieter Rosenland, Wegberg (DE)

Correspondence Address: Proskauer Rose;Patent Department, 1585 Broadway, New York, NY, 10036, US

(21) Appl. No.: 10/581,961

(22) PCT Filed: Nov. 3, 2004
(86) PCT No.: PCT/EP04/12408

§ 371 Date: Apr. 10, 2007

(30) Foreign Application Priority Data
Dec. 9, 2003 (DE) 203 19 063.7

(51) Int. Cl. B23B 5/32

(52) U.S. Cl. 82/105

(57) ABSTRACT

A service carriage including a device for the support of a chassis with at least two pairs of individual wheels or at least two wheel sets and which are installed in the chassis turnable around their respective axis of rotation, is designed to support the remaining wheel sets of the chassis during the machining process on a wheel set machining unit. A support is provided in a longitudinal direction at a distance from the machining tools of the wheel set machining unit, by which one of the wheel sets not being machined at the time can be received during machining.

The innovation relates to a device for supporting chassis—with at least two pairs of individual wheels or at least two wheel sets which are mounted to the chassis turnable around their respective axis of rotation—for rail vehicles during the machining of the individual wheels, wheels or wheel sets or parts thereof on a wheel set machining unit, whereby the respective axes of rotation of the pairs of individual wheels or the wheel sets are provided with a lateral axle base from each other in the longitudinal direction of the chassis.

During the machining of individual wheels or wheel set of a chassis, for example a bogie, of rail vehicles on an underfloor wheel set lathe, the parts of the chassis or of the bogie, whose wheels or wheel sets are not being machined at the time, usually rest on the repair track. However, such a support is not possible for chassis or bogies of rail vehicles, which must be lifted during machining so that the wheel set machining unit can be moved underneath. But a support of the parts is required to be able to meet the machining accuracy as well as the safety regulations.

The innovation is based on the task to suggest such a support.

In order to solve the problem it is intended to provide a support for a free individual wheel not being machined at the time of a pair of individual wheels or at least for a wheel of a wheel set of the chassis in longitudinal direction of the rail vehicle at a distance to the machining tools of the wheel set machining unit corresponding to an axle base. For example bogies have axle bases, which may vary completely depending on the individual types of design. So, intended with the innovation on hand is the option during machining to support individual wheels of chassis with individual wheels or pairs of individual wheels only or with individual wheel sets of bogies with two or more wheel sets.

Corresponding to a favourable design the support for the individual wheels or the wheel set not being machined should be connectable at least temporarily to the wheel set machining unit. In the simplest case the support consists of a vertical pillar with a horizontal cross member at its top end, extending in longitudinal direction and equipped with a device to support an individual wheel or a wheel of a wheel set. However, usually the support consists of two vertical pillars, which are laterally spaced in longitudinal direction and are connected at their top ends with a horizontal cross member extending in longitudinal direction and equipped with a device to support an individual wheel or a wheel of a wheel set.

Usually not only one wheel of a wheel set or an individual wheel of a chassis alone is machined but two wheels simultaneously, which face each over the distance of the gauge. So they are arranged transversely to the longitudinal direction of the rail vehicle. In this direction, meaning transverse to the longitudinal direction, there is another support provided also consisting of a vertical pillar with a horizontal cross member at the top end extending in longitudinal direction and with a device supporting individual wheels or a wheel of a wheel set. So, looking in longitudinal direction of the rail vehicle the two supports face each other with the same distance of respective machining tools of the wheel set machining unit. These machining tools can be turning tools, with which the outline profile of the railway wheels is machined, however, they can also be turning tools provided for the machining of brake discs usually arranged on the railway axle.

Both supports are connected via another cross member extending across the cross member in longitudinal direction across the width of the wheel set machining unit. Then, another support is provided across the width of the wheel set machining unit consisting of two vertical pillars spaced laterally and connected at their top ends via a horizontal cross member extending in longitudinal direction and provided with a device supporting an individual wheel or a wheel of a wheel set.

So, looking in longitudinal direction the two supports face each other with the same distance of respective machining tools of the wheel set machining unit. Also the two supports are connected via another cross member extending across the cross member in longitudinal direction across the width of the wheel set machining unit.

At one of the supports a spacer is provided which can be used in a direction across to the longitudinal direction to adjust or lock the distance of the support of an individual wheel, a wheel set or the bogie. The spacer is provided near the foot of at least one of the vertical pillars of the support.

The innovative device can also be designed as part of a service container firmly or detachably connected to the wheel set machining unit. DE 202 14 918.8 of the applicant describes such a service container for a mobile wheel set machining unit. Because the mobile wheel set machining unit is travelling on rollers it can be connected to a service carriage, which is also travelling. Travelling preferably takes place in the direction of the repair track.

Finally a wagon carrier truck is provided on the support with two rollers facing each other in longitudinal direction at a distance and which are designed to hold an individual wheel or a wheel of a wheel set. The wagon carrier trucks are movable and lockable on the cross member in longitudinal direction and can thus be adjusted to the respective axle base of a bogie.

The wagon carrier truck ensures that also the second wheel set of a drive bogie can be supported, of which the two wheel sets are coupled with each other. Each wheel set of the chassis supported on the wagon carrier truck can then turn idle while the other wheel set is being machined.

Finally a stop for an individual wheel or a wheel of a wheel set is attached to the cross member extending in longitudinal direction to align the chassis in transverse direction, i.e. for the alignment related to the machining centre of the wheel set machining unit or the centre of the repair track.

In the following the innovation will be specified in greater detail by describing two embodiments thereof.

They each show in a reduced scale

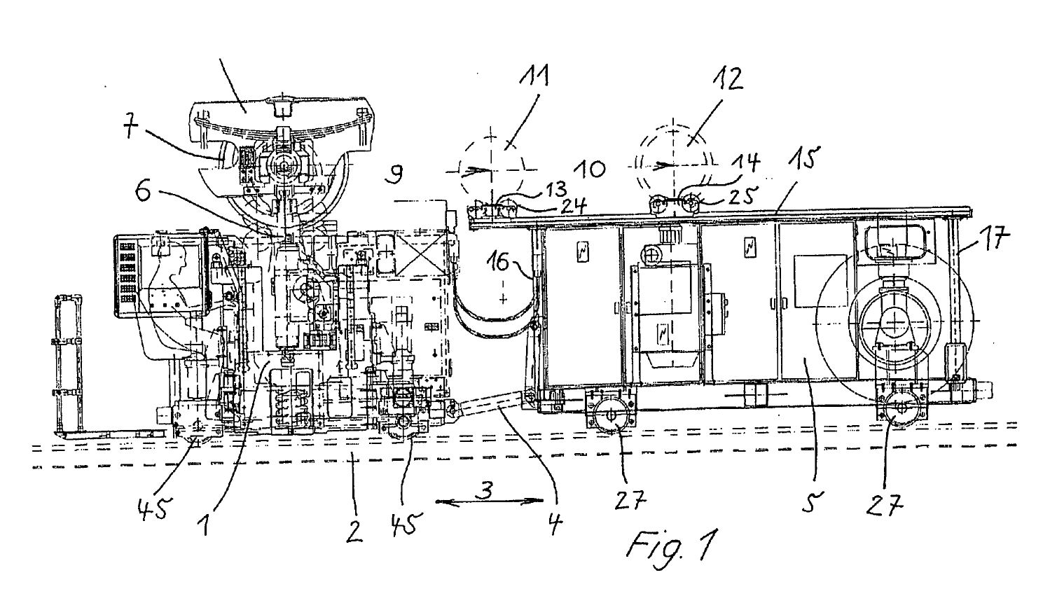

FIG. 1 a wheel set machining unit with a service container in side view,

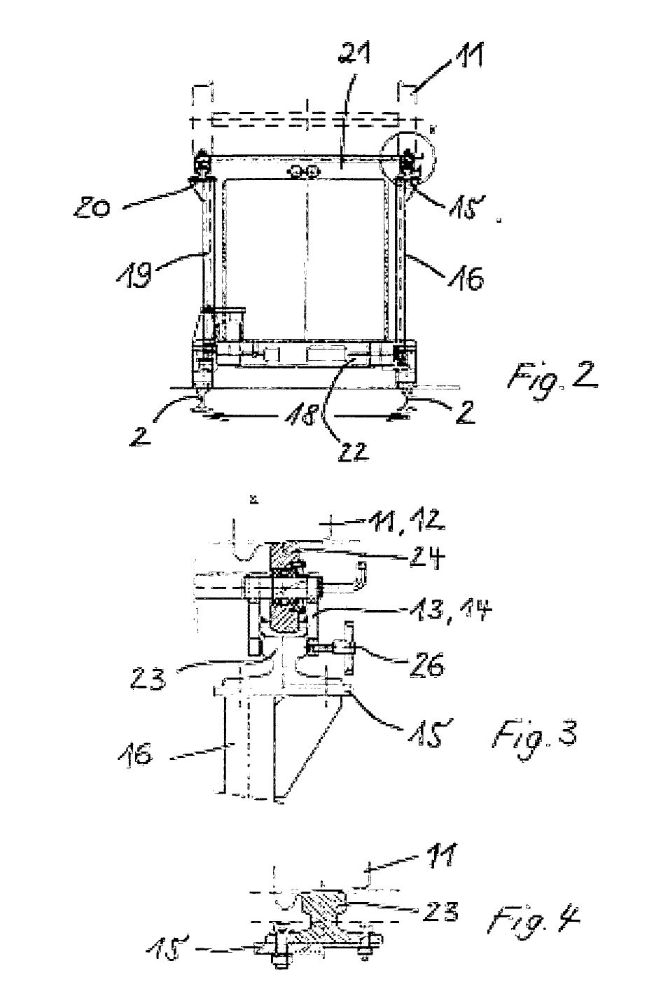

FIG. 2 a support in front view,

FIG. 3 detail X according to FIG. 2 in enlarged view,

FIG. 4 an additional support for a railway wheel,

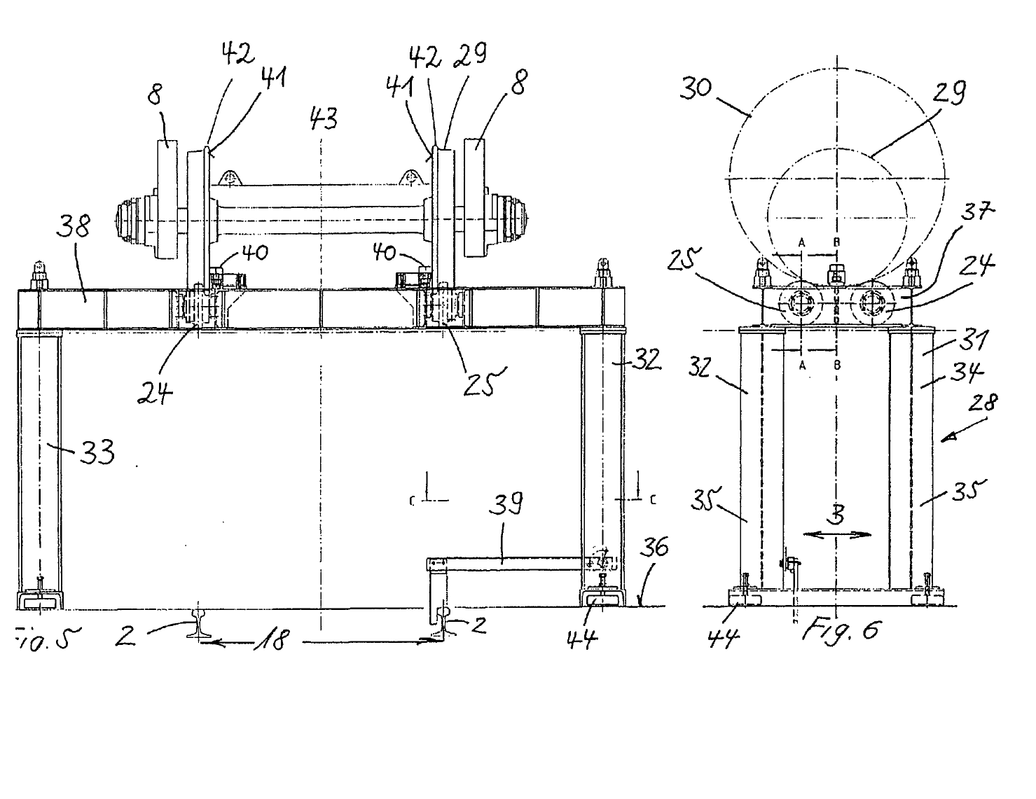

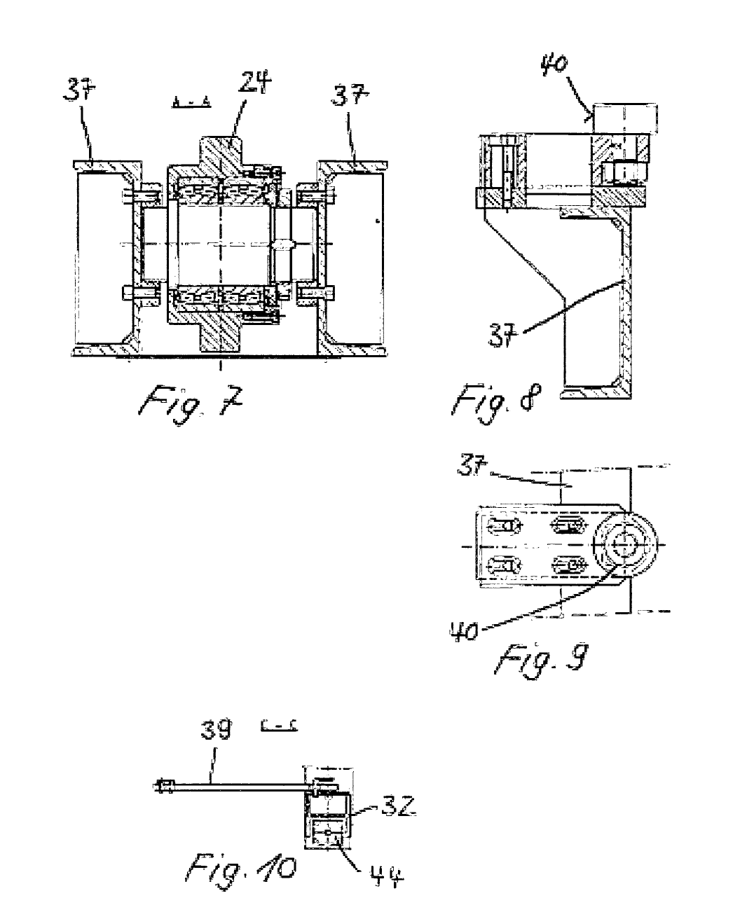

FIG. 5 a second embodiment of a support in front view,

FIG. 6 the support of FIG. 5 in side view,

FIG. 7 a detail along cut A-A of FIG. 6,

FIG. 8 a detail according to cut B-B of FIG. 6,

FIG. 9 a plan view onto the detail of FIG. 8 and

FIG. 10 a cut along line C-C of FIG. 5.

A wheel set machining unit 1 is travelling on a repair track 2 in longitudinal direction 3 of a railway vehicle. A service container 5 is detachably connected with the wheel set machining unit 1 via a coupling rod 4. The wheel set machining unit 1 is equipped with tools 6 provided for the machining of the outline profile of a railway wheel 7. Railway wheel 7 is part of a wheel set, which in return is part of a bogie 8, which is lifted up on the wheel set machining unit 1. In an axle base 9 or 10 the second wheel set 11 or 12 is located being part of the bogie 8. The wheel sets 11 and 12 are each indicated by interrupted circles. The wheel sets 11 and 12 each rest on roller carriers 13 and 14. The roller carriers 13 or 14 are shiftable in the axle base 9 or 10 on a cross member 15 resting on two vertical pillars 16 and 17. The cross member 15 extends in longitudinal direction 3 and on the cross member 15 the roller carriers 13 and 14 are moveable and lockable in longitudinal direction 3.

The support of the second wheel set 11 or 12 of a bogie 8 by one of the roller carriers 13 or 14 is of advantage if the second wheel set 11 or 12 must co-rotate, while the first wheel set 7 is machined on the wheel set machining unit 1. This, for example, is the case in a drive bogie (not shown), in which two wheel sets 7 and 11 or 7 and 12 are coupled to each other. The type of coupling may vary, for example, mechanically via gear wheels or universal joints or also electrically or via a pressure medium.

The vertical pillars 16 and 17 are firmly connected to the service container 5. Above the gauge 18 of the repair track 2 a vertical pillar 19 is facing the pillar 16 as also the pillar 17 is facing a fourth vertical pillar (not shown). The vertical pillars 16 to 19 and the vertical pillar facing the vertical pillar 17 are therefore connected to all four comers of the service container 5. Thus with the space of the gauge 18 two cross members 15 and 20 extend in longitudinal direction 3 across the service container 5 and rest on the vertical pillars 16 to 19. Cross braces 21 and 22 connect the vertical pillars 16 and 19 in the top and bottom area of the service container 5.

In the simplest case the cross members 15 and 20 support on their upper side a rail section 23, on which the wheel sets 11 or 12 rest. For coupled wheel sets 7, 11, 12 the wheel sets 11 or 12 can also be supported by roller carriers 13 or 14; the cut of one of them is shown in FIG. 3. The roller carriers 13 or 14 each have two rollers 24 or 25, which are spaced from each other in longitudinal direction 3 so that the wheel set 11 or 12 is supported on them and can be turned. By means of an adjusting device 26 the roller carriers 13 or 14 are clamped to the rail section 23 on the cross member 15 or 20. Here various axle bases 9 or 10 can be set. Analogue to the wheel set machining unit 1 the service container 5 is travelling back and forth on rollers 27 in longitudinal direction 3 on the repair track 2.

According to the design example of the FIGS. 5 and 6 the support 28 for the chassis 8 of a rail vehicle with the wheel sets 29 and 30 consists of four vertical pillars 31 to 34. With their bottom ends 35 the pillars 31 to 34 each rest on the shop floor 36. At their top ends they are connected by cross members 37, which extend in longitudinal direction 3 and cross members 38, which extend across to the repair track 2 and are wider than the gauge 18. The centre distance to the repair track 2 ensures a device 39, which, for example, is provided at the bottom end 35 of the vertical pillar 32. The rollers 24 and 25 of the example on hand are integrated into the cross member 37. FIG. 7 shows this integration in detail.

Pinch rolls 40, which can be attached to the inside 41 of the wheel flanges 42 of the wheel set 29 fasten the wheel set 29 with regard to the centre 43 of the wheel set machining unit 1 or the repair track 2. The pinch rolls 40 are held on the cross member 37 by an adjustable holder 45. Finally FIG. 10 shows the spacer 39 in plan view. Via an additional adjusting device 44 the pillars 31 to 34 can also be aligned with respect to their vertical height.

### LIST OF REFERENCE MARKS

1. Wheel set machining unit
2. Repair track
3. Longitudinal direction
4. Coupling rod
5. Service carriage
6. Tools
7. Railway wheel
8. Bogie
9. Axle base
10. Axle base
11. Wheel set
12. Wheel set
13. Roller carrier
14. Roller carrier
15. Cross member
16. Vertical pillar
17. Vertical pillar
18. Track gauge
19. Vertical pillar
20. Cross member
21. Cross brace
22. Cross brace
23. Rail section
24. Roller
25. Roller
26. Clamping device
27. Roller
28. Support
29. Wheel set
30. Wheel set
31. Pillar
32. Pillar
33. Pillar
34. Pillar
35. Bottom end
36. Shop floor
37. Cross member
38. Cross member
39. Spacer
40. Pinch roll
41. Inside
42. Wheel flange
43. Centre
44. Alignment
45. Shiftable holder

1. A service carriage comprising a device for supporting chassis with at least two pairs of individual wheels or at least two wheel sets, which are mounted to the chassis turnable around their respective axis of rotation, for rail vehicles during the machining of the individual wheels, wheels of the wheel sets or parts thereof on a wheel set machining unit,
wherein the respective axes of rotation of the pairs of individual wheels or the wheel sets are provided with a lateral axle base from each other in a longitudinal direction of the chassis,
wherein in the longitudinal direction at a distance from the machining tools of the wheel set machining unit corresponding to an axle base, a support is provided for at least one free individual wheel of a pair of individual wheels or at least one wheel of a wheel set of the chassis always not being machined at the time,
wherein the service carriage is firmly or detachably connected to the wheel set machining unit.

2. The service carriage according to claim 1, wherein the wheel set machining unit and the service carriage are able to travel on rollers.

3. The service carriage according to claim 2, wherein the wheel set machining unit and the service carriage are able to travel on the repair track.

4. The service carriage according to claim 1, wherein the support on a horizontal cross member provided in the longitudinal direction has a wagon carrier truck with two rollers provided in the longitudinal direction facing each other at a distance, and for receiving one individual wheel or a wheel of a wheel set.

5. The service carriage according to claim 3, wherein another support is provided across the width of the wheel set machining unit consisting of a vertical pillar with a horizontal cross member at its top end extending in the longitudinal direction and provided with a device supporting one individual wheel or a wheel of a wheel set.

6. The service carriage according to claim 3, wherein both supports face each other in the longitudinal direction by having the same distance from respective machining tools of the wheel set machining unit.

7. The service carriage according to claim 6, wherein both supports are connected by another cross member extending across to the cross members in the longitudinal direction across the width of the wheel set machining unit.

8. The service carriage according to claim 4, wherein another support is provided across the width of the wheel set machining unit consisting of two vertical pillars being at a lateral distance from each other and connected by a horizontal cross member at their top ends extending across to the longitudinal direction and provided with a device supporting one individual wheel or a wheel of a wheel set.

9. The service carriage according to claim 8, wherein both supports face each other across to the longitudinal direction by having the same distance from respective machining tools of the wheel set machining unit.

10. The service carriage according to claim 9, wherein both supports are connected by at least one other cross member extending across to the cross members in the longitudinal direction across the width of the wheel set machining unit.

11. The service carriage according to claim 1, wherein at least one of the supports has a spacer via which the distance of the support to an individual wheel, a wheel set or the chassis is movable and lockable in a direction across to the longitudinal direction.

12. The service carriage according to claim 11, wherein the spacer is provided near the foot of at least one of the vertical pillars of the support.

13. (canceled)

14. (canceled)

15. (canceled)

16. (canceled)

17. The service carriage according to claim 4, wherein the wagon carrier truck is moveable and lockable on the cross member in the longitudinal direction.

18. Device according to claim 17, wherein a stop for one individual wheel or a wheel of a wheel set is provided for the alignment of the chassis in the longitudinal direction along the cross member extending in the longitudinal direction.
